(19) United States
(12) Patent Application Publication
(10) Pub. No.: US 2017/0058768 A1
(43) Pub. Date: Mar. 2, 2017

(54) Method And Device For Storing And Recovering Energy

(71) Applicant: Mitsubishi Hitachi Power Systems Europe GmbH, Duisburg (DE)

(72) Inventors: Christian Bergins, Datteln (DE); Torsten Buddenberg, Moers (DE)

(73) Assignee: Mitsubishi Hitachi Power Systems Europe GmbH, Duisburg (DE)

(21) Appl. No.: 15/303,004

(22) PCT Filed: Jan. 30, 2015
(86) PCT No.: PCT/EP2015/051919

§ 371 Date: Oct. 9, 2016

(30) Foreign Application Priority Data
Apr. 11, 2014 (DE) 10 2014 105 237.4

(51) Int. Cl. F02C 3/22; F02C 6/14; F25J 1/00; F02C 3/04

(52) U.S. Cl. CPC F02C 3/22; F02C 3/04; F02C 6/14; F25J 1/0012; F05D 2220/32; F05D 2220/76

(57) ABSTRACT

The invention relates to a method for storing and recovering energy, wherein an air liquefaction product (LAIR) is formed during an energy storage period, and a fluid pressure flow (12) is formed during an energy recovery period using at least one part of the air liquefaction product (LAIR) and is expanded for operation in at least one energy recovery device (14, 17). The air liquefaction product (LAIR) is obtained as a liquid medium during the energy storage period by compressing air in an air conditioning device (3), said compression being operated while supplying energy, in particular while supplying a current (9), optionally stored in a cold state, and fed to an evaporator unit (7). The air liquefaction product (LAIR) is expanded for operation as a fluid pressure flow (12) in the at least one energy recovery device (14, 17) during the energy recovery period after a pressure increase. The aim of the invention is to provide a solution with which even existing gas and steam power plants or open gas turbines are to be equipped with an energy storage capability. This is achieved in that the fluid pressure flow (12), in particular an air flow, is expanded in a first energy recovery device (14) and conducted through a recuperator device (13), in particular a heat boiler, upstream of said first energy recovery device (14), and thermal energy which has been decoupled from a flue gas flow (23) fed to the recuperator device (13) is coupled into the fluid pressure flow (12) in said heating tank. The flue gas flow (23) is fed to the recuperator device (13) from a fuel-fired second energy recovery device (17), in particular a gas turbine.

The present invention relates to a method of storing and recovering energy, in which an air liquefaction product (LAIR) is formed in an energy storage period and a fluid pressure stream is formed using at least a portion of the air liquefaction product (LAIR) in an energy recovery period and is expanded to perform work in at least one energy generation device; in which the air liquefaction product (LAIR) is obtained as liquid medium in the energy storage period by compression of air, operated with supply of energy, in an air conditioning device, if desired stored in the cold state in a storage unit designed as a liquid storage means, and sent to an evaporator unit and in which the air liquefaction product (LAIR) is expanded to perform work at least in the energy recovery period after a pressure increase as the fluid pressure stream in the at least one energy generation device.

The invention further relates to a device, especially for performance of a method as claimed in any of claims 1-12, which is set up for storage and recovery of energy by formation of an air liquefaction product (LAIR) in an energy storage period and for production and work-performing expansion of a fluid pressure stream formed using at least a portion of the air liquefaction product (LAIR) in an energy recovery period, comprising an air conditioning device that can be operated with supply of energy, by means of which the air liquefaction product (LAIR) can be produced as liquid medium by compression of air, an air liquefaction product storage device, a conveying device that compresses the air liquefaction product (LAIR) in a pressure-increasing manner to give the fluid pressure stream and at least one energy generation device which is connected by conduits to the conveying device and expands the fluid pressure stream to perform work.

DE 31 39 567 A1 and EP 1 989 400 A1, for example, disclose use of liquefied air or liquefied nitrogen, i.e. cryogenic air liquefaction products, for grid control and for provision of control power in power grids.

In cheap power periods or power surplus periods, air is liquefied in an air fractionation plant with an integrated liquefier or in a dedicated liquefaction plant, generally also referred to as air treatment unit, as a whole or in part to give such an air liquefaction product. The air liquefaction product is stored in a tank system having low-temperature tanks. This mode of operation is effected in a period which is referred to here as energy storage period.

In peak load periods, the air liquefaction product is withdrawn from the tank system, its pressure is increased by means of a pump, and it is warmed to about ambient temperature or higher and hence converted to a gaseous or supercritical state. A pressure stream obtained in this way is expanded up to ambient pressure in a power plant unit in one or more expansion turbines with intermediate heating. The mechanical power released is converted to electrical energy in one or more generators of the power plant unit and fed into an electrical grid. This mode of operation is effected in a period which is referred to here as energy recovery period.

The cooling energy released in the course of conversion of the air liquefaction product to the gaseous or supercritical state during the energy recovery period can be stored and used during the energy storage period for provision of cooling energy to obtain the air liquefaction product.

There are also known compressed air storage power plants in which the air, however, is not liquefied but compressed in a compressor and stored in an underground cavern. At times of high power demand, the compressed air from the cavern is passed into the combustion chamber of a gas turbine. At the same time, the gas turbine is supplied with fuel, for example natural gas, via a gas conduit and combustion is effected in the atmosphere formed by the compressed air. The offgas formed is expanded in the gas turbine, which generates energy.

DE 197 57 88 A1 discloses a power generation system having a gas turbine and an energy storage means comprising a storage vessel for storage of liquid air, an evaporation unit for evaporation of the liquid air stored in the storage vessel, a combustion chamber for production of a combustion gas by combustion of the air evaporated by the evaporation unit and of fuel, and additionally a gas turbine which is driven by the combustion gas generated in the combustion chamber and a gas turbine generator connected to the gas turbine for generation of electrical power. For supply of the liquid air to the evaporation unit, a pressure-increasing unit is provided, by means of which the liquid air stored in the storage vessel is brought to a pressure higher than the pressure of the air which is supplied to the combustion chamber. The system further comprises an expansion turbine which is driven by expansion of the air evaporated by the evaporation unit, and an expansion turbine generator connected to the expansion turbine for generation of power.

A method of operating a stationary power plant is additionally known from AT 012 844 U1. In this method, an energy conversion device assigned to a gas engine is operated by an organic Rankine cycle process, wherein the energy conversion device, for evaporation of at least one biphasic working medium, is supplied with waste heat from the gas engine, and the energy conversion device, for condensation of the working medium, is supplied with liquefied cold air from a liquid air storage device.

The combination of a gas turbine with the utilization of an air liquefaction product, with heat exchange between the offgas from the gas turbine and the air liquefaction product, and with operation both of a generator for power generation with the air liquefaction product in an expansion stage and of a generator for power generation by means of the gas turbine, is known from US 2012/0151961 A1. Such a combination of a gas turbine with an energy generation plant that generates power by means of expanded air liquefaction product is additionally known from U.S. Pat. No. 3,631,673 A.

The option of liquefying air and storing it as air liquefaction product in a tank, from which it is later fed to a power-generating expansion stage, is known from US 2011/0132032 A1.

The present invention should also be distinguished from methods and devices in which an oxygen-rich fluid is introduced into a gas turbine to promote oxidation reactions. Corresponding methods and devices fundamentally work with air liquefaction products containing (much) more than 40 mole percent of oxygen.

The economic viability of corresponding methods and devices is greatly influenced by the overall efficiency. It is therefore an object of the invention to improve corresponding methods and devices in this respect.

It is a further object of the invention to provide a solution with which existing gas and steam power plants or open gas turbines too can be equipped with an energy storage means.

The above objects are achieved by a method as claimed in claim 1 and a device as claimed in claim 13. Advantageous and appropriate configurations of the invention are the subject of the respective dependent claims.

To achieve the above object, the invention proposes a method in which the fluid pressure stream, especially air stream, is expanded in a first energy generation device and, downstream of this first energy generation device, is passed through a recuperator device, especially a waste heat boiler, in which heat energy abstracted from a flue gas stream fed to the recuperator device, especially the waste heat boiler, is injected into the fluid pressure stream, the flue gas stream being fed to the recuperator device, especially the waste heat boiler, from a fuel-fired second energy generation device, especially a gas turbine.

The invention likewise proposes, for achievement of the above objects, a device, especially for performance of a method as claimed in any of claims 1 to 12, wherein, in the conduit connection upstream of a first energy generation device through which the fluid pressure stream flows in flow direction of the fluid pressure stream, a recuperator device, especially a waste heat boiler, is disposed through which the fluid pressure stream flows, in which heat energy abstracted from a flue gas stream fed to the recuperator device, especially the waste heat boiler, can be injected into the fluid pressure stream, the recuperator device, especially the waste heat boiler, being within a conduit connection that supplies the flue gas stream to a fuel-fired second energy generation device, especially a gas turbine.

The invention thus relates to liquid air energy storage (LAES) technology, in which power is used to produce and to store liquid air. The liquid air can then at a later stage, in the event of (high) power demand, be brought to high pressure with a pump in an energy-efficient manner and then heated in an energy generation unit and then expanded.

With the invention, it is now possible also to equip and supplement existing gas and steam power plants having a gas turbine as at least one energy generation device with an energy storage means for an air liquefaction product. In this way, it is possible to achieve higher efficiency with acceptable capital costs. But the invention is advantageous from the point of view of improving efficiency for new constructions as well.

To achieve these aims, the invention proposes providing, as well as a fuel-fired (second) energy generation device, a first energy generation device through which the fluid pressure stream obtained by evaporation of the air liquefaction product flows and in which it is expanded, and at the same time thermally coupling the fluid pressure stream fed to the first energy generation device and the flue gas stream originating from the fuel-fired second energy generation device with one another in a recuperator or waste heat boiler in such a way that heat energy abstracted from the flue gas stream is injected into the fluid pressure stream. This makes it possible to heat up the fluid pressure stream having a pressure of 40 to 100 bar at ambient temperature in this region to a temperature of >400° C., especially >450° C., and especially to a temperature of 500° C.

The invention therefore envisages, in a configuration of the method, that the fluid pressure stream is fed to the recuperator at a pressure of 30-100 bar, preferably 55-75 bar, and is heated therein by means of the heat energy injected to a temperature of >400° C., especially >450° C.

Before a gas and steam power plant is equipped with the method of the invention and the device of the invention, it is possible at first to operate such a power plant as a “normal” gas and steam power plant or as a peak load power plant. However, it is also possible, even if the energy storage devices are present with the air liquefaction, not to operate these, but ultimately to operate the fuel-fired (second) energy generation device, especially a gas turbine. In this case, the recuperator or waste heat boiler is not used to heat the fluid pressure stream. But when the energy storage portion is switched on, additional output power is available immediately when liquefied air is held ready in an air liquefaction product storage device. Such an air liquefaction product storage device, especially a tank that stores liquid air, additionally enables the absorption of surplus amounts of power from the grid when the assigned air conditioning device and especially the air-liquefying air compression device are operated with surplus power from the grid. Here, in addition, the option is also created of operating power to gas or power to fuel plants, which take the surplus power that originates, for example, from generation by means of renewable energies from the grid and store it in the form of water and/or carbonaceous fuel.

Because of the inventive configuration, it is possible in all process variants to use gas turbines that only have to be slightly modified compared to known mass-produced machines. The air expanders which are also needed, i.e. the expansion unit that forms the expansion stage, especially an expansion turbine of the first energy generation device, are also available as derivatives of known steam turbines that are obtainable on the market or can be manufactured therefrom without any great difficulty. It is likewise possible to modify the recuperator or waste heat boiler provided in accordance with the invention by minor adaptation of waste heat boilers that are known in connection with gas and steam power plants.

At pressures of the fluid pressure stream of 50 bar up to 80 bar and inlet temperatures of the fluid pressure stream into the expanding first energy generation device, especially the expansion stage thereof, of 450° C. up to 550° C., storage efficiencies with the aid of cooling energy storage and liquefaction of air of more than 50% are possible. If still further measures, such as the supply of additional cooling energy from outside processes or the introduction of compressed air into the fuel-fired second energy generation device, especially gas turbine, are additionally provided, it is possible to increase the efficiencies to 55% to 65%. If, in addition, the waste heat that arises in the air compression in the air compressor device or air compressor plant is fed into a district heating grid or into a process heating grid and hence sent to a use at another site, utilization levels based on the fuel (fuel efficiency in the retrieving of energy from storage) of more than 80%, in the individual case even up to 100%, are possible.

It is also advantageously possible with the invention to implement the combination of a chemical energy storage means with a liquid air storage means (liquid air energy storage=LAES) when, at the site of the LAES plant, a plant which enables the preparation of methane, methanol or demethyl ester with hydrogen preferably originating from an electrolysis and with the conversion of CO₂ is operated, which products are then supplied as fuel to the fuel-fired second energy generation device.

In a configuration, the invention envisages that the fluid pressure stream is expanded in at least one first expansion stage, especially a first expansion turbine, of the first energy generation device to a pressure of ≦0.2 bar and is preferably released to the environment.

In this context, it is additionally also advantageous when the fluid pressure stream is expanded in the at least one first expansion stage, especially the first expansion turbine, of the first energy generation device to a pressure of ≧10 bar, preferably to a pressure between 10 bar and 25 bar, then a substream is branched off and fed to the fuel-fired second energy generation device, especially the combustion chamber thereof, which is likewise envisaged by the invention.

A further appropriate and advantageous coupling between the first energy generation device and second energy generation device also arises, in a configuration of the invention, in that the fluid pressure stream is expanded in the first expansion stage, especially a first expansion turbine, of the first energy generation device to a pressure of ≧10 bar, preferably ≧14 bar, then a substream is branched off and fed to the fuel-fired second energy generation device, especially the combustion chamber thereof, and the remaining residual substream is fed to a third expansion stage, especially a third expansion turbine, of the first energy generation device.

In the case of such a coupling of first energy generation device and fuel-fired second energy generation device, it is additionally appropriate to match the substream of the fluid pressure stream fed from the first energy generation device to the fuel-fired second energy generation device to the mass flow of air supplied to the second energy generation device. It is therefore a further feature of the invention that the substream of the fluid pressure stream fed to the second energy generation device, especially a combustion chamber of the fuel-fired second energy generation device, corresponds to 2%-40%, preferably 5%-15%, of the mass flow of air which is compressed in the operation of the second energy generation device, especially the gas turbine, by at least one compressor stage, especially a compressor turbine, of the second energy generation device.

The air supplied to the fuel-fired second energy generation device, especially the gas turbine, and/or the fluid pressure stream supplied can be fed here to a compression stage or a compressor or especially to a compression turbine, but it is also possible to feed the above-specified proportion by mass of air and/or the fluid pressure stream to the fuel-fired second energy generation device, especially gas turbine, for shaft and blade cooling.

The substream of the fluid pressure stream that has been withdrawn after a partial expansion in the first expansion stage, especially the first expansion turbine, of the first energy generation device and fed to the second energy generation device leaves the first energy generation device preferably with a temperature in the range from 150° C. to 450° C., especially from 300° C. to 400° C.

The fuel-fired second energy generation device may be configured as a two-shaft gas turbine which is supplied with the substream of the fluid pressure stream originating from the first energy generation device, with independently controllable shaft speeds and at least one shaft having controllable speed in the two-shaft gas turbine.

The recuperator or waste heat boiler may be a tube heat exchanger in which the flue gas stream supplied releases its residual heat to the incoming cold fluid pressure stream in one or more stages, the cold fluid pressure stream being conducted within the tubes of the tube heat exchanger. However, it is also possible to undertake the abstraction of heat from the flue gas stream in a recuperator or waste heat boiler in the form of a plate heat exchanger comprising one or more stages, in which case the waste heat boiler releases the cold fluid pressure stream supplied. Here too, the fluid pressure stream is conducted within the plate heat exchanger or the tubes thereof. Of course, the formation of two or more recuperators/waste heat boilers is also possible. The recuperator(s)/waste heat boiler(s) preferably comprise(s) one or more heat exchanger stages, the tubes or plates of which consist of an austenitic material. In this case, the plate or heat exchangers may—at least in part—take the form of tubes with outer fins. Since the recuperator/waste heat boiler of the invention may in principle be constructed like waste heat boilers or recuperators of gas and steam power plants, through which the offgas or flue gas from the gas turbine is conducted therein, it may also be the case here that the heat exchanger units are arranged horizontally or vertically. It is also possible to provide heat exchange surfaces for heating of the fluid pressure stream, which are supplied with steam and/or hot water from a dedicated further (parallel) energy generation plant or a storage means for supply of heat to the fluid pressure stream.

More particularly, such plants are then, as is known from conventional gas and steam power plants, simultaneously equipped with a catalyst which brings about denoxing of the flue gas stream passed through the heat exchanger, i.e. the recuperator/waste heat boiler. In this case, the heat exchanger or recuperator/waste heat boiler is then in at least two-stage form, and a unit for denoxing the flue gas stream by means of a catalyst and, for example, ammonia or aqueous ammonia is arranged between the stages. It is another feature of the invention, in a development, that the flue gas stream is passed through a recuperator device which brings about denoxing, especially a waste heat boiler. It is an additional feature of the invention, in a configuration of the method, that the flue gas stream fed to the recuperator device, prior to entry into the recuperator device, is supplied with a fresh air stream at ambient temperature in such an amount that the flue gas stream is cooled prior to entry into the recuperator device to a temperature between 250° C. and 500° C., especially between 310° C. and 430° C. It is also appropriate, additionally or alternatively, to generate cooling of the flue gas stream by means of water spraying among other methods. It is therefore a further feature of the invention that the flue gas stream, prior to entry into the recuperator device, is cooled by means of sprayed introduction of water to a temperature of 250° C. to 500° C., especially between 310° C. and 430° C.

This solves the problem that, in a gas turbine-LAES combined cycle power plant, during the sole operation of the gas turbine system in gas turbine mode of the combined cycle power plant, the flue gas stream from the fuel-fired second energy generation device, especially a gas turbine, is not cooled in the recuperator device by the fluid pressure stream likewise conducted through the recuperator device. But this would mean that the flue gas, on entry into the catalytic denoxing unit or denoxing device formed within the recuperator device would then have a temperature, at about 510° C. to 550° C., which is too high for the operation of a catalytic denoxing temperature. Such catalytic denoxing devices which enable selective catalytic reduction (“SCR”), however, require a temperature window within the range from 310° C. to 430° C. Above this temperature window, the catalyst present in the respective denoxing device begins to sinter; below this temperature window, the catalytic reaction of nitrogen oxides becomes too slow to bring about sufficient denoxing of the flue gas stream within the customary residence time.

It may be the case here that the flue gas stream originating from the fuel-fired second energy generation device, especially the/a gas turbine, is contacted with ambient air, especially by means of an additional fresh air supply, meaning that a mixing temperature within the permissible temperature range/temperature window for the operation of an SCR catalyst is attained. This additional air stream is supplied at a mass flow rate which, depending on the exit temperature of the flue gas stream from the second energy generation device, is about 40% by weight of the flue gas mass flow rate. It may be the case here that the cold ambient air is mixed in in the existing flue gas pathway by means of unutilized recuperator heating surfaces. However, it is also possible to provide and configure a separate flue gas pathway designed exclusively for this case of operation of the gas turbine mode, through which the flue gas stream then flows. A further option is to install optionally connectable bypass channels in the existing flue gas pathway, which thus increase the cross section through which the flue gas stream can flow and hence lower the flue gas flow rate and the pressure drop. However, the bypass channels may also be provided for bypassing of the recuperator heating surfaces, since these heating surfaces constitute the lowest flow cross section in the LAES mode of the power plant in which both the liquid air storage means and the gas turbine are being operated.

Alternatively, in a configuration of the invention, it may also be the case that the flue gas stream is cooled by means of sprayed introduction of water before it reaches the catalyst surface or catalyst unit. Such a solution may possibly necessitate sprayed injection of water after the stream has flowed through the catalyst unit or device as well, in order to further lower the flue gas temperature and to establish conditions on the offgas side of the recuperator device as also attained in LAES operation in which the cold fluid pressure stream is passed through the recuperator device.

In the case of a recuperator device equipped with a denoxing device, it may be additionally the case that measures which lead to lowering of the temperature of the flue gas stream are also already taken in the second energy generation unit. It is possible here, for example, to operate the air compressor or the air compression device of the air liquefaction plant and to use the compressed air generated to cool the heating surfaces in the recuperator arranged upstream of the denoxing unit in the recuperator device in flow direction of the flue gas. The compressed air produced here can then be conducted to an expansion stage or expansion turbine of an energy generation device and utilized for power generation. However, it is also possible to cool the flue gas stream by means of an additional and/or existing heating surface of the recuperator device, by virtue of flow of a fluid which is subsequently used to charge a thermal storage means through this additional/existing heating surface. Since a thermal storage means always has a limited capacity and the duration of the gas turbine mode of the power plant has to be made variable in terms of its duration, it is then necessary to provide the option of discharging the amount of heat removed from the flue gas stream to the environment by means of a further heat exchange operation. The thermal storage means may contain either a gaseous or a solid or liquid storage medium. The heat stored can subsequently be utilized, in pure LAES mode, i.e. without gas turbine operation, to preheat the stored liquid air in the form of the fluid pressure stream prior to expansion in an expansion stage of the first energy generation device, if, for example, the second energy generation unit should not be operated.

Overall, it is thus possible to operate a device of the invention firstly by the method of the invention in which the stored cryogenic and liquid air is compressed with a pump and evaporated in an evaporator unit. The fluid pressure stream established thereafter (about 60 bar) then has a temperature close to ambient temperature (20° C.). Since, in this mode of operation in LAES mode, the fuel-fired second energy generation device, especially gas turbine, moreover, is likewise in operation, the waste heat from the flue gas stream is then utilized to heat the air originating from a liquid air storage means, i.e. a storage unit, in the form of the fluid pressure stream to a temperature close to the temperature of the flue gas stream. The fluid pressure stream preheated in this way is then expanded in a downstream expansion stage of the first energy generation device in flow direction. In this LAES mode, the first and second energy generation devices are thus operated in parallel and utilized for power production. In a mode of operation in GT (gas turbine) mode in which only the second energy generation device is in operation, the power is generated solely with this second energy generation device.

The air conditioning device comprising the compression unit, and also the liquefaction unit and the evaporator unit, can preferably be connected to the district heating grid or a process heat grid. In this case, the heat originating from the air compression (compression unit) and/or liquefaction unit will then be supplied to a district heating grid or a process heat grid. It is therefore a feature of the invention, in a development, that the waste heat of compression that arises in the compression of air in the air conditioning device is stored and/or provided as district heat and/or as process heat. However, it is also possible to feed at least a portion of this stored waste heat of compression at a later stage as process heat to the evaporator unit and/or to the fluid pressure stream prior to entry thereof into the recuperator device for evaporation and/or heating of the air liquefaction product. However, the energy needed for the evaporation and/or heating of the air liquefaction product may also originate from a parallel energy generation plant.

The invention also envisages, in a configuration, that heat energy is abstracted from the output air stream leaving the first energy generation device and/or from the flue gas stream leaving the recuperator device and made available as district heat and/or as process heat.

On the liquefaction side of the plant or device of the invention, it may be the case that the liquefaction unit is supplied with surplus cooling energy from outside processes, i.e. processes not directly connected to the method of the invention. Such an outside process may be the evaporation of natural gas or liquid natural gas. It is therefore a feature of the invention, in a development, that the air conditioning device comprising a liquefaction unit, an evaporator unit and preferably a cooling energy storage means is supplied with cooling energy that arises in other evaporation processes, especially cooling energy originating from the evaporation of natural gas or liquid natural gas.

The fuel-fired second energy generation device may be fired with a wide variety of different fuels. These may be fuel which has been produced on the basis of the storage of power in the form of chemical energy, i.e. prepared in a synthetic manner. This may be hydrogen originating from an electrolysis, methane originating from a power-to-gas plant, there being additional conversion of methane in the power-to-gas plant by reaction of hydrogen originating from an electrolysis with CO₂ preferably originating from a flue gas, or dimethyl ether (DME). Preferably, these synthetic fuels have a proportion corresponding to the energy stored in the liquid air, i.e. the fluid pressure stream, in relation to the total amount of fuel supplied to the gas turbine. The energy (energy of reaction) of the fuel of the second energy generation device may originate from nuclear energy or renewable energy, for example geothermal energy, photovoltaics, solar-thermal energy (CSP), wind energy or biomass. More particularly, the carbon atoms of the fuel in the case of the energy storage of the invention may originate from fossil fuels that have undergone energy recycling or the CO₂ that forms therefrom in the course of combustion or oxidation thereof.

At the site of the device of the invention in an energy storage plant by means of liquefied air, it is additionally possible to install a chemical energy storage plant which stores energy by means of electrolysis and/or power-to-gas and/or power-to-fuel, in which case this stored fuel partly or wholly constitutes the fuel for the fuel-fired second energy generation device.

As already mentioned above, for optimization of the energy efficiency of a device of the invention for performance of a method of the invention, especially as claimed in one or more of claims 1-12, i.e. of an energy storage plant or energy storage device, it is possible to utilize the heat energy present in the flue gas stream downstream of the recuperator device in flow direction and that present in the waste air that forms after the expansion of the fluid pressure stream of the first energy generation device, or else the waste heat energy available in the production of storable fuels, for the provision of process heat or district heat.

It is a feature of the device of the invention that the first and second energy generation devices are connected to one another in a conduit connection that supplies a substream of the fluid pressure stream.

In a development, the invention envisages design of the first energy generation device and/or the fuel-fired second energy generation device, especially the/a gas turbine, in the form of a generator turbine.

It is additionally advantageous here that the first energy generation device and/or the fuel-fired second energy generation device, especially the/a gas turbine, have/has at least one expansion stage that expands the fluid pressure stream supplied, especially an expansion turbine.

In another development of the invention, the first energy generation device and/or the fuel-fired second energy generation device, especially the/a gas turbine, have/has at least one compression stage that compresses the fluid gas stream supplied and/or air supplied, especially a compression turbine.

It is also advantageous in a development of the invention that a flue gas denoxing unit is configured and arranged within the recuperator device, especially waste heat boiler, preferably between two heat exchanger stages, which is likewise envisaged by the invention.

It is advantageous in a further configuration of the invention when the air conditioning device is configured such that it comprises a liquefaction unit and an evaporation unit, and also preferably a cooling energy storage unit.

Overall, the device of the invention is ultimately designed to be usable to conduct the method of the invention therewith, and for that reason it has means that have been set up for performance of a method as claimed in any of claims 1-12.

The invention is elucidated in detail by way of example hereinafter with reference to a drawing.

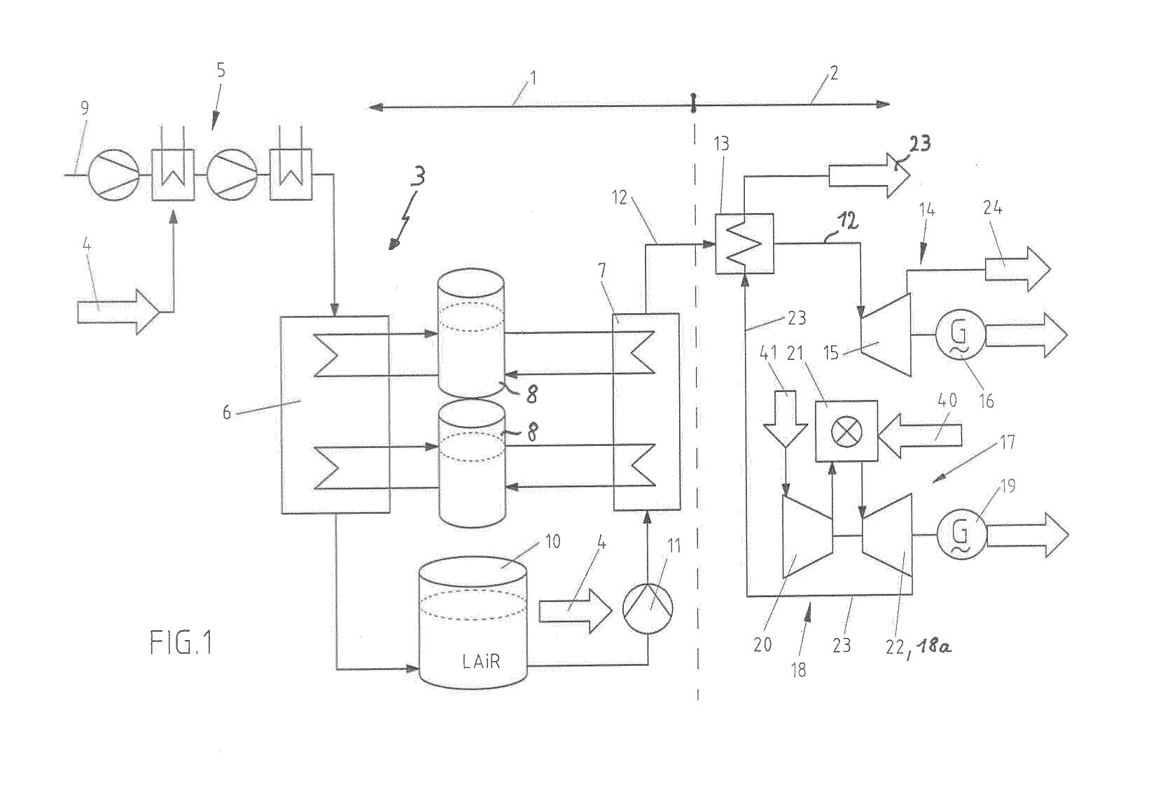

The drawing shows, in FIGS. 1-9, working examples of the device of the invention for performance of the method of the invention in schematic view.

FIGS. 1-9 illustrate identical, analogous or basically corresponding elements, apparatuses, devices and fluid streams with identical reference signs, and for the sake of clarity they are not elucidated again in all cases. This is all the more true in that the individual variants according to FIGS. 1-9 differ from one another in partial regions only.

FIG. 1 shows a device of the invention in the form of an energy storage plant 1 and an energy generation plant 2. In the energy storage plant 1, an air liquefaction product (LAIR) is formed in an energy storage period. For this purpose, in an air conditioning device 3 comprising a compression unit 5 operated with power 4, a liquefaction unit 6 and an evaporator unit 7 with dedicated cooling energy storage means 8, an air liquefaction product (LAIR) is prepared from air 9 supplied to the compressor unit 5. The air liquefaction product (LAIR) is (intermediately) stored in a storage device 10 configured as a liquid storage means, such that this storage unit 10 constitutes an air liquefaction product storage device. In order to be able to utilize the energy stored in this air liquefaction product (LAIR) again in the energy generation plant 2, this air liquefaction product is fed to the evaporator unit 7 with the aid of a conveying device configured as a pump 11 within an energy recovery period, flows through it and is then available in the form of a “cold” fluid pressure stream 12 with a pressure in the range between 30 and 10 bar, preferably 30 and 90 bar, especially 40 to 70 bar, most preferably 55-75 bar, and ambient temperature. It is also possible here that the air liquefaction product (LAIR) is not (intermediately) stored in the storage unit 10 but fed to the pump 11 immediately after it has been generated. The “cold” fluid pressure stream 12 is conveyed through a recuperator device 13 to a first energy generation device 14. In the working example according to FIG. 1, the first energy generation device 14 comprises a first expansion stage 15 with a connected generator 16, the first expansion stage 15 taking the form of an expansion turbine.

The energy generation plant 2 further comprises a fuel-fired second energy generation device 17 in the form of a gas turbine unit 18, especially of an open gas turbine 18a with a connected generator 19. The gas turbine unit 18 has a compression stage 20, especially a compression turbine, by means of which air 41 supplied is compressed and fed to a combustion chamber 21. In the combustion chamber 21, the compressed air 41 is combusted with fuel supplied, natural gas 40 in the working example, and the offgas stream formed is passed to a second expansion stage 22, especially an expansion turbine, of the gas turbine unit 18. The flue gas leaving the second expansion stage 22, having a temperature of more than 400° C., especially a temperature in the range of 450-500° C., is likewise fed to the recuperator device 13 as flue gas stream 23. In the recuperator device 13, heat is exchanged between the flue gas stream 23 and the fluid pressure stream 12 in such a way that heat energy is abstracted from the flue gas stream 23 and injected into the fluid pressure stream 12. After flowing through the recuperator device 13 in the form of a waste heat boiler, the fluid pressure stream 12 has a temperature of more than 400° C., preferably more than 450° C., especially a temperature in the range of 500-550° C. This fluid pressure stream 12 that has now been heated to a high temperature is fed to the expansion stage 15 of the first energy generation device 14 and expanded such that the air 24 released to the environment still has a pressure of ≦0.2 bar. In the case of this combined operation of first energy generation device 14 and second energy generation device 17, power is generated by means of the two generators 16 and 19.

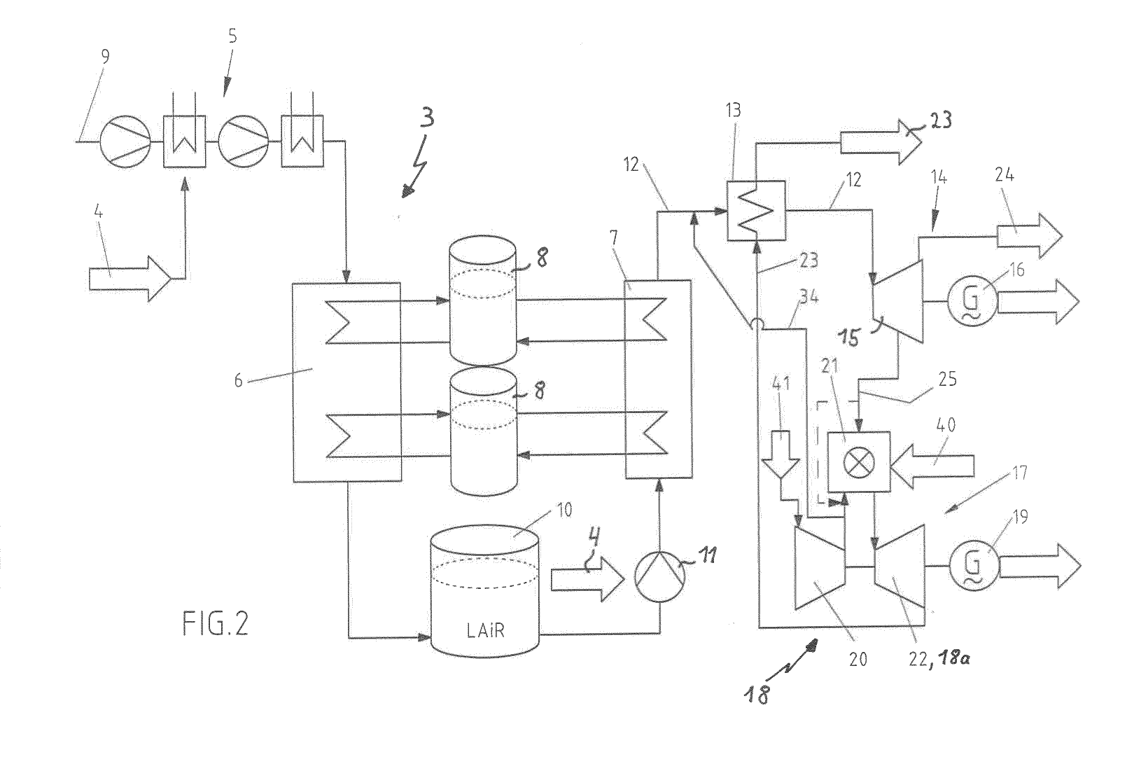

In the embodiment according to FIG. 2, by contrast with the embodiment according to FIG. 1, a substream 25 of the fluid pressure stream 12 is branched off from the first expansion stage 15 of the first energy generation device 14 after the fluid pressure stream has been expanded in the first expansion stage 15 to a pressure of >10 bar, preferably a pressure between 10 bar and 25 bar. This substream 25 of the fluid pressure stream is fed to the combustion chamber 21 of the second energy generation device 17. In addition, a substream 34 is branched off from the air stream of the air 41 having a temperature of about 450° C. at the end of the compression stage 20, which has been compressed in the compression stage 20, and is mixed into the fluid pressure stream 12 upstream of the recuperator device 13, such that the latter is already heated prior to entry into the recuperator device 13. In this case, the substream 25 can be mixed into the residual substream of compressed air 41 fed to the combustion chamber 21 even before it enters the combustion chamber 21, as indicated by a dotted line in FIG. 2.

The further configuration is as in the embodiment according to FIG. 1.

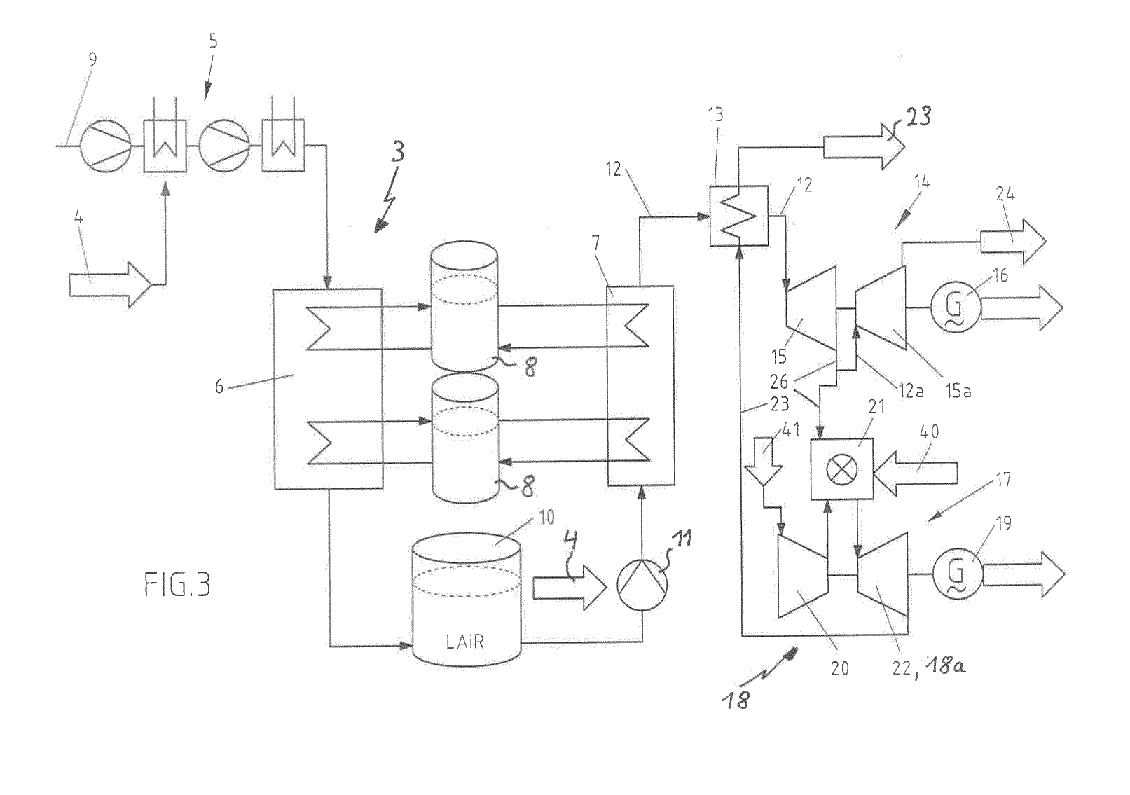

The embodiment according to FIG. 3 differs from the preceding embodiments in that the expansion stage of the first energy generation device 14 is in two-stage form and comprises the first expansion stage 15 and a third expansion stage 15a. Here, the fluid pressure stream 12 is expanded in the first expansion stage 15 to a pressure of >10 bar, preferably >14 bar, and then fed to the third expansion stage 15a. Between the first and third expansion stages 15, 15a, a substream 26 of the fluid pressure stream 12 is branched off and fed to the combustion chamber 21 of the second energy generation device 17. The remaining residual substream 12a of the fluid pressure stream 12 is fed to the third expansion stage 15a of the first energy generation device 14.

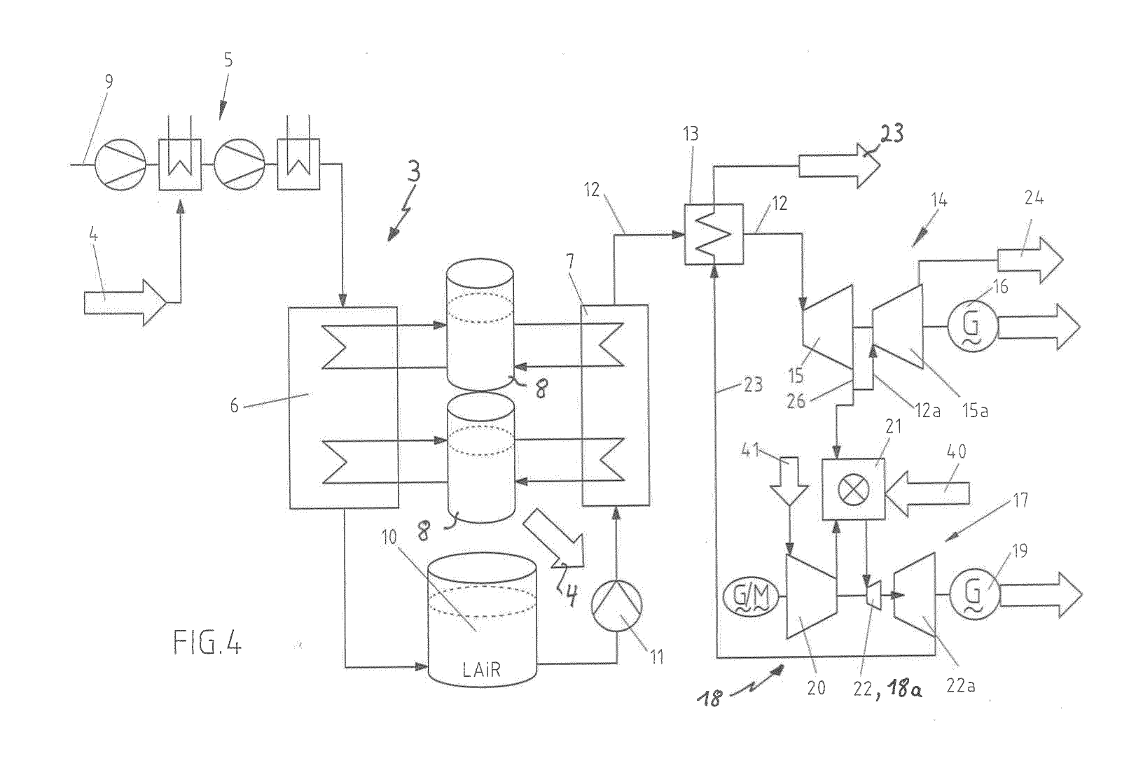

The embodiment according to FIG. 4 differs from that according to FIG. 3 merely in that the expansion stage of the second energy generation device 17 is also in two-stage form and comprises the second expansion stage 22 and a fourth expansion stage 22a.

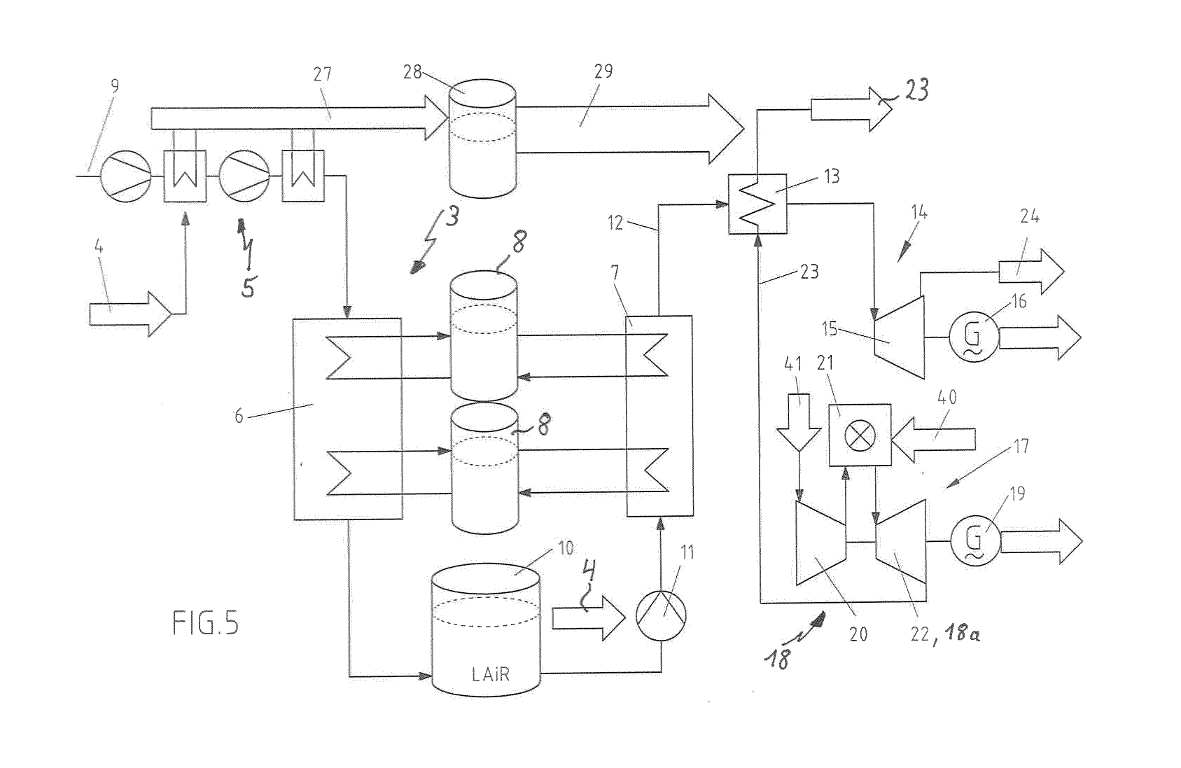

The embodiment according to FIG. 5 is supposed to illustrate that the waste heat of compression 27 that arises in the compression of the air 9 supplied in the compression unit 5 can be stored in a heat storage means 28 and then supplied to a district heating grid and/or a process heat grid 29.

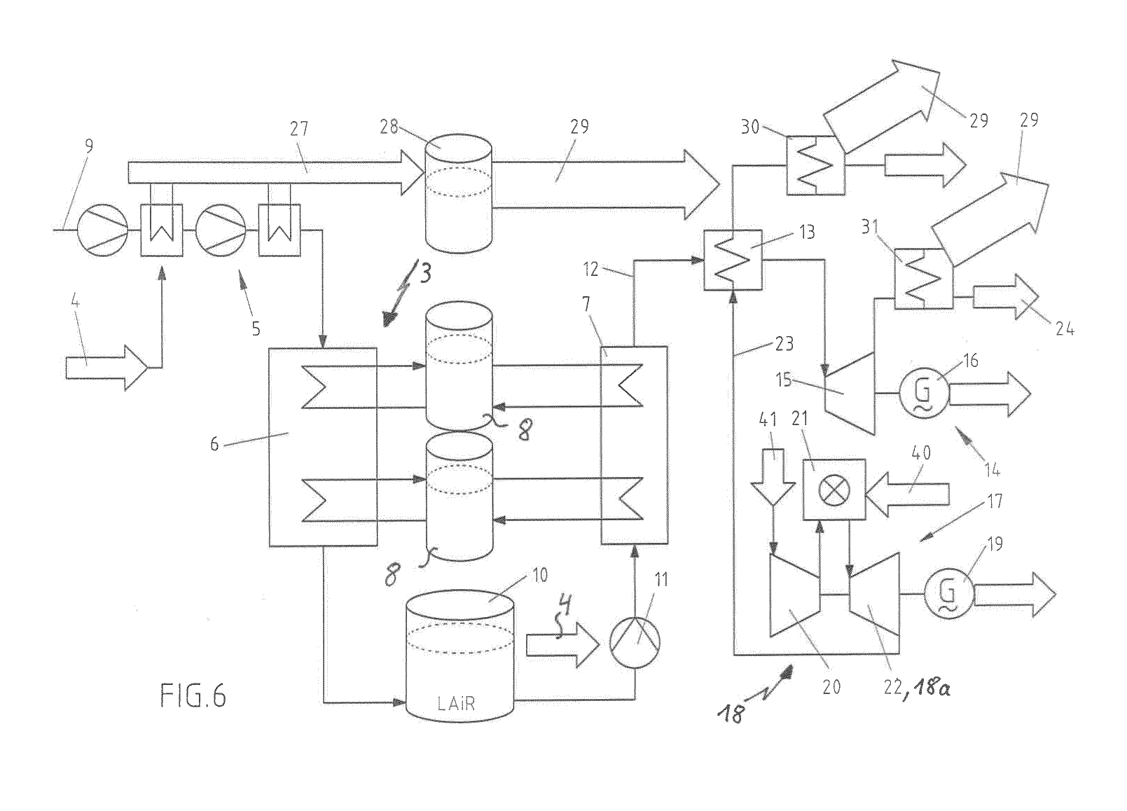

FIG. 6 illustrates that it is also possible to arrange a heat exchanger 30 downstream of the recuperator device 13, and this can be used to withdraw residual heat still present in the flue gas stream 23 and likewise supply it to the district heating grid and/or process heat grid 29. It is likewise possible to feed the output air 24 leaving the first energy generation device 14 to a heat exchanger 31 in which, in turn, heat energy still present in the output air 24 can be abstracted and then made available to the district heating grid and/or process heat grid 29.

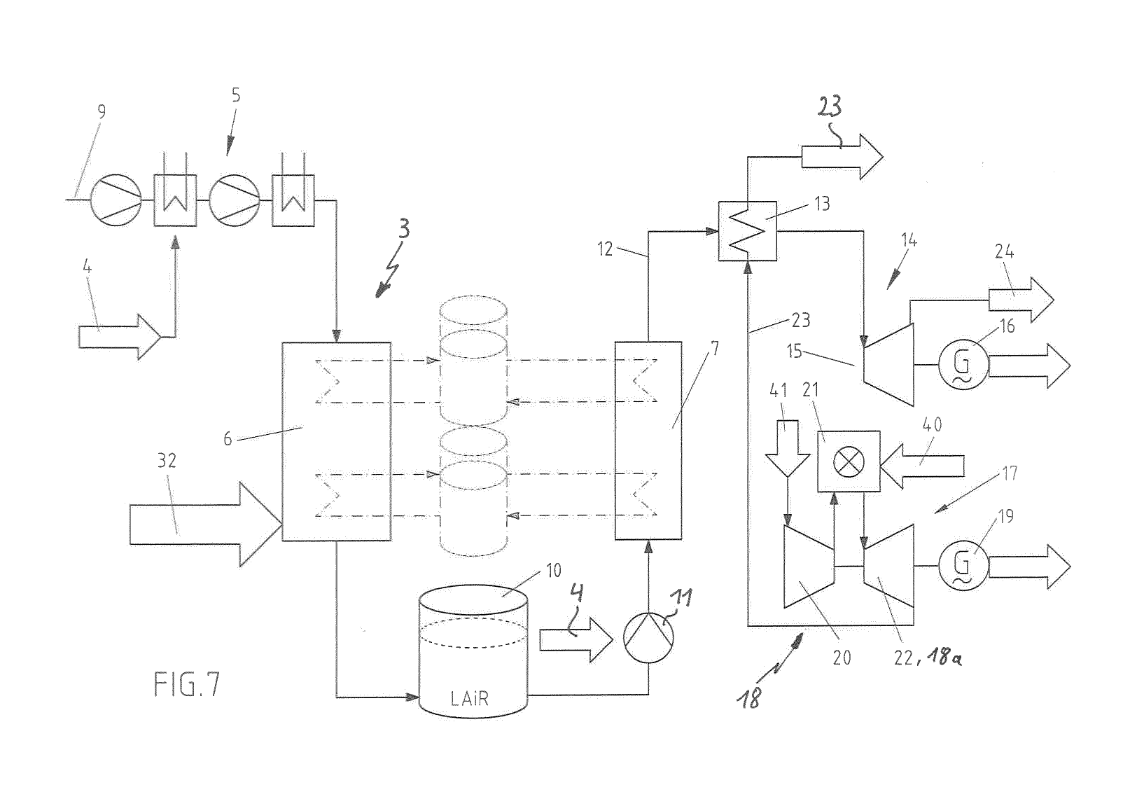

FIG. 7 shows that cooling energy/surplus cooling energy 32 originating from other processes, especially evaporation processes, preferably from the compression of natural gas or liquid natural gas, can be fed to the air conditioning device 3 and can be used here particularly in the liquefaction unit 6.

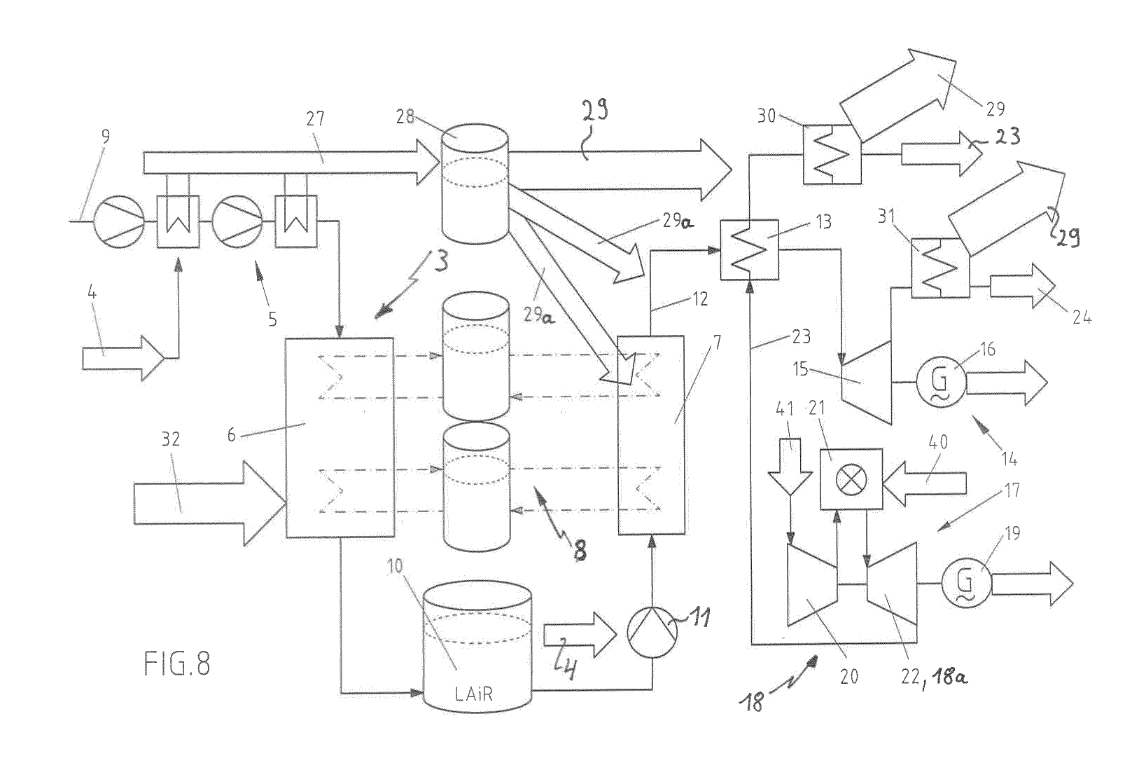

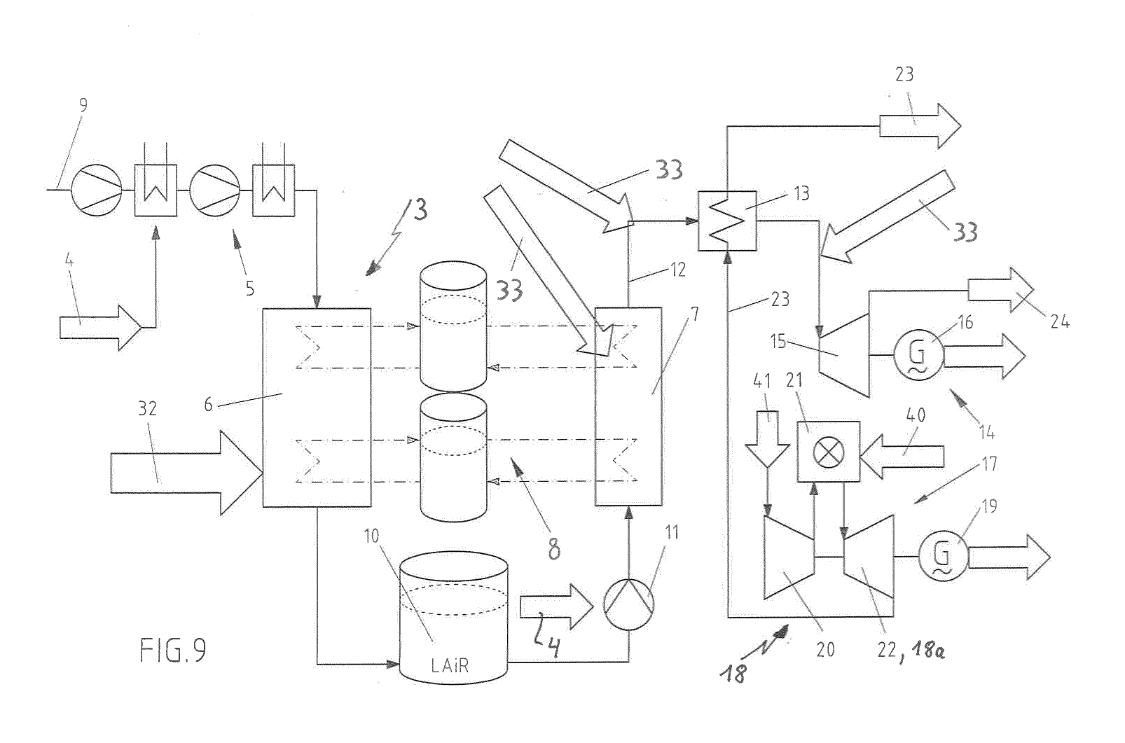

While FIG. 8 illustrates that the heat energy stored in the heat storage means 28 can also be fed in the form of process heat 29a to the evaporator unit 7 or to the fluid pressure stream 12, FIG. 9, finally, shows that outside heat 33 can also be used in order to supply heat energy to the evaporator unit 7 and/or to the fluid pressure stream 12 upstream and/or downstream of the recuperator device 13 in flow direction.

An “air liquefaction product” in the context of the invention is any product which can be produced in the form of a cryogenic liquid at least by compression, cooling and subsequent expansion of air. More particularly, an air liquefaction product may be liquid air, liquid oxygen, liquid nitrogen and/or a liquid noble gas such as liquid argon. The terms “liquid oxygen” and “liquid nitrogen” each also refer to a cryogenic liquid including oxygen or nitrogen in an amount above that in atmospheric air. Thus, these liquids need not necessarily be pure liquids having high contents of oxygen and nitrogen respectively. Liquid nitrogen is thus understood to mean either pure or essentially pure nitrogen or a mixture of liquefied air gases whose nitrogen content is higher than that of atmospheric air. For example, the latter has a nitrogen content of at least 90 and preferably at least 99 mole percent.

The terms “energy storage period” and “energy recovery period” are especially understood to mean periods of time that do not overlap. This means that the measures described above and below for the energy storage period are typically not conducted during the energy recovery period, and vice versa. However, it may also be the case, for example in a further period, that at least some of the measures described for the energy storage period are conducted simultaneously with the measures described for the energy recovery period, for example in order to assure greater continuity in the operation of a corresponding plant. For example, it is also possible to supply a fluid pressure stream 12 in an energy storage period of a unit or energy generation plant 12 set up for energy generation and to expand it so as to perform work therein, for example in order to be able to operate the compressor used here without shutdown. The energy storage period and energy recovery period each correspond to a mode of operation or process mode of a corresponding plant or corresponding method.

1. A method of storing and recovering energy, in which an air liquefaction product (LAIR) is formed in an energy storage period and a fluid pressure stream is formed using at least a portion of the air liquefaction product (LAIR) in an energy recovery period and is expanded to perform work in at least one energy generation device,
in which the air liquefaction product (LAIR) is obtained as liquid medium in the energy storage period by compression of air, operated with supply of energy, in an air conditioning device, and sent to an evaporator unit
and in which the air liquefaction product (LAIR) is expanded to perform work at least in the energy recovery period after a pressure increase as the fluid pressure stream in the at least one energy generation device,
characterized in that
the fluid pressure stream is expanded in a first energy generation device and, downstream of this first energy generation device, is passed through a recuperator device in which heat energy abstracted from a flue gas stream fed to the recuperator device is injected into the fluid pressure stream, the flue gas stream being fed to the recuperator device from a fuel-fired second energy generation device.

2. The method as claimed in claim 1, wherein the fluid pressure stream is fed to the recuperator at a pressure of 30-100 bar and is heated therein by means of the heat energy injected to a temperature of >400° C.

3. The method as claimed in claim 1, wherein the fluid pressure stream is expanded in at least one first expansion stage of the first energy generation device to a pressure of ≦0.2 bar.

4. The method as claimed in claim 1, wherein the fluid pressure stream is expanded in the at least one first expansion stage of the first energy generation device to a pressure of ≧10 bar, then a substream is branched off and fed to the fuel-fired second energy generation device.

5. The method as claimed in claim 1, wherein the fluid pressure stream is expanded in the first expansion stage of the first energy generation device to a pressure of ≧10 bar, then a substream is branched off and fed to the fuel-fired second energy generation device, and the remaining residual substream is fed to a third expansion stage of the first energy generation device.

6. The method as claimed in claim 4, wherein the substream of the fluid pressure stream fed to the second energy generation device corresponds to 2%-40% of the mass flow of air which is compressed by at least one compressor stage of the second energy generation device in operation of the second energy generation device.

7. The method as claimed in claim 1, wherein the flue gas stream is passed through a recuperator device which brings about denoxing.

8. The method as claimed in claim 1, wherein the flue gas stream fed to the recuperator device, prior to entry into the recuperator device, is supplied with a fresh air stream at ambient temperature in such an amount that the flue gas stream is cooled prior to entry into the recuperator device to a temperature between 250° C. and 500° C.

9. The method as claimed in claim 1, wherein the flue gas stream, prior to entry into the recuperator device, is cooled by means of sprayed introduction of water to a temperature of 250° C. to 500° C.

10. The method as claimed in claim 1, wherein the waste heat of compression that arises in the compression of air in the air conditioning device is stored and/or provided as district heat and/or as process heat.

11. The method as claimed in claim 1, wherein heat energy is abstracted from the output air stream leaving the first energy generation device and/or from the flue gas stream leaving the recuperator device and made available as district heat and/or as process heat.

12. The method as claimed in claim 1, wherein the air conditioning device comprising a liquefaction unit and an evaporator unit is supplied with cooling energy that arises in other evaporation processes.

13. A device for storage and recovery of energy by formation of an air liquefaction product (LAIR) in an energy storage period and for production and work-performing expansion of a fluid pressure formed using at least a portion of the air liquefaction product (LAIR) in an energy recovery period, the device comprising
an air conditioning device that can be operated with supply of energy, by means of which the air liquefaction product (LAIR) can be produced as liquid medium by compression of air,
a conveying device that compresses the air liquefaction product (LAIR) in a pressure-increasing manner to give the fluid pressure stream and
at least one energy generation device which is connected by conduits to the conveying device and expands the fluid pressure stream to perform work,
in the conduit connection upstream of a first energy generation device through which the fluid pressure stream flows in flow direction of the fluid pressure stream, a recuperator device is disposed through which the fluid pressure stream flows, in which heat energy abstracted from a flue gas stream fed to the recuperator device can be injected into the fluid pressure stream, the recuperator device being within a conduit connection that supplies the flue gas stream to a fuel-fired second energy generation device.

14. The device as claimed in claim 13, wherein the first and second energy generation devices are within a conduit connection that supplies a substream of the fluid pressure stream.

15. The device as claimed in claim 13, wherein the first energy generation device and/or the fuel-fired second energy generation device take(s) the form of a generator turbine(s).

16. The device as claimed in claim 13, wherein the first energy generation device and/or the fuel-fired second energy generation device have/has at least one expansion stage that expands the fluid pressure stream supplied.

17. The device as claimed in claim 13, wherein the first energy generation device and/or the fuel-fired second energy generation device have/has at least one compression stage that compresses the fluid pressure stream supplied and/or air supplied.

18. The device as claimed in claim 13, wherein a flue gas denoxing unit is configured and arranged within the recuperator device.

19. The device as claimed in claim 13, wherein the air conditioning device comprises a liquefaction unit, an evaporation unit and a cooling energy storage unit.

20. The device as claimed in claim 13, wherein it has means that have been set up to conduct a method in which an air liquefaction product (LAIR) is formed in an energy storage period and a fluid pressure stream is formed using at least a portion of the air liquefaction product (LAIR) in an energy recovery period and is expanded to perform work in at least one energy generation device,
in which the air liquefaction product (LAIR) is obtained as liquid medium in the energy storage period by compression of air, operated with supply of energy, in an air conditioning device, and sent to the evaporator unit,
and in which the air liquefaction product (LAIR) is expanded to perform work at least in the energy recovery period after a pressure increase as the fluid pressure stream in the at least one energy generation device,
characterized in that
the fluid pressure stream is expanded in the first energy generation device and, downstream of this first energy generation device, is passed through the recuperator device in which heat energy abstracted from a flue gas stream fed to the recuperator device is infected into the fluid pressure stream, the flue gas stream being fed to the recuperator device from a fuel-fired second energy generation device.
